(19) United States
(12) Patent Application Publication
(10) Pub. No.: US 2024/0248628 A1
(43) Pub. Date: Jul. 25, 2024

(54) TIERED MEMORY DATA STRUCTURES AND ALGORITHMS FOR UNION-FIND

(71) Applicant: VMware LLC, Palo Alto, CA (US)

(72) Inventors: Siddhartha Visveswara Jayanti, Hanover, NH (US); Marcos Kawazoe Aguilera, Mountain View, CA (US); Naama Ben David, Mountain View, CA (US)

(21) Appl. No.: 18/158,993

(22) Filed: Jan. 24, 2023

(51) Int. Cl. G06F 3/06

(52) U.S. Cl. CPC G06F 3/0647; G06F 3/0626; G06F 3/0685

(57) ABSTRACT

In one set of embodiments, a computer system comprising first and second memory tiers can receive a request to carry out union-find with respect to a set of n elements. The computer system can then initialize a disjoint-set forest comprising a plurality of trees, each tree including a node corresponding to an element in the set of n elements, and can execute one or more union-find operations on the disjoint-set forest, where the initializing and the executing comprises storing a threshold number of nodes of highest rank in the disjoint-set forest in the first memory tier.

### BACKGROUND

Unless otherwise indicated, the subject matter described in this section is not prior art to the claims of the present application and is not admitted as being prior art by inclusion in this section.

Modern computer systems use a tiered memory architecture that comprises a hierarchy of different memory types, referred to as memory tiers, with varying cost and performance characteristics. For example, the highest byte-addressable memory tier of this hierarchy typically consists of dynamic random-access memory (DRAM), which is fairly expensive but provides fast access times. The lower memory tiers of the hierarchy include slower but cheaper (or at least more cost efficient) memory types such as persistent memory, remote memory, and so on.

Because of the differences in performance across memory tiers, it is desirable for applications to place more frequently accessed data in higher (i.e., faster) tiers and less frequently accessed data in lower (i.e., slower) tiers. However, many data structures and algorithms that are commonly employed by applications today are not designed with tiered memory in mind. Accordingly, these existing data structures and algorithms fail to adhere to the foregoing rule, resulting in suboptimal performance.

### BRIEF DESCRIPTION OF THE DRAWINGS

FIG. 1 depicts an example tiered memory system.

FIG. 2 depicts an example disjoint-set forest.

FIG. 3 depicts a flowchart for implementing tiered memory union-find according to certain embodiments.

FIG. 4 depicts a flowchart for implementing tiered memory union-find via static allocation according to certain embodiments.

FIGS. 5A and 5B depict a flowchart for implementing tiered memory union-find via dynamic allocation according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

Embodiments of the present disclosure are directed to data structures and algorithms that may be implemented by a computer system with a tiered memory architecture (i.e., a tiered memory system) for efficiently solving the union-find problem (also known as disjoint-set-union or set-union). Generally speaking, these data structures and algorithms, referred to herein as tiered memory data structures/algorithms, ensure that most of the memory accesses needed to execute union-find operations are directed to data maintained in higher (i.e., faster) memory tiers and conversely few memory accesses are directed to data maintained in lower (i.e., slower) memory tiers. This results in improved performance over standard union-find algorithms that assume a single tier of memory.

### 1. Example Tiered Memory System and Problem Statement

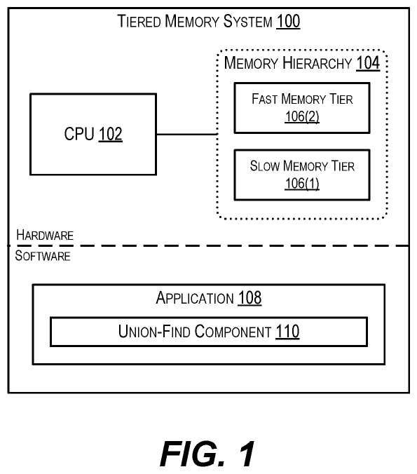

FIG. 1 is a simplified block diagram of an example tiered memory system 100 in which the techniques of the present disclosure may be implemented. As shown, tiered memory system 100 includes in hardware a central processing unit (CPU) 102 that is coupled with a memory hierarchy 104. Memory hierarchy 104 is a logical collection of memory tiers that are ordered from highest to lowest. Each memory tier represents a different type of physical memory present in tiered memory system 100 and accessed by CPU 102, with higher memory tiers consisting of faster but more expensive (and thus scarcer) memory and lower memory tiers consisting of slower but cheaper (and thus more abundant) memory.

In the example of FIG. 1, memory hierarchy 104 includes two memory tiers: a fast memory tier 106(2) (also referred to herein as simply “fast memory”) that has an associated size m and cost per memory access c, and a slow memory tier 106(1) (also referred to herein as simply “slow memory”) that has an associated size M>m and cost per memory access C>c. For example, fast memory tier 106(2) may comprise DRAM, which offers memory access times on the order of tens of nanoseconds but is typically limited in size to several hundred gigabytes. In contrast, slow memory tier 106(1) may comprise persistent memory (also known as non-volatile RAM or NVRAM), which offers slower memory access times on the order of hundreds of nanoseconds but can feasibly reach capacities of several terabytes or more. In alternative embodiments, memory hierarchy 104 may include further memory tiers beyond 106(2) and 106(1).

In addition to CPU 102 and memory hierarchy 104, tiered memory system 100 includes in software an application 108 comprising union-find component 110. Union-find component 110 is tasked with solving the union-find problem, which involves implementing a data structure U (referred to herein as a union-find data object) that maintains a collection of disjoint sets. Each set S in this collection has a unique representative element. Generally speaking, union-find data object U supports the following operations:
1. U←Initialize(n): create a new union-find data object U with n elements organized as n singleton sets (e.g., {1}, {2}, . . . , {n}). The single element in each set is its representative.
2. U·Unite(x, y): if x and y are in different sets Sₓ and S_{y}, then replace the sets Sₓ and S_{y} in the collection with the set Sₓ∪S_{y}, and choose an arbitrary representative element for the newly made set. Otherwise, if x and y are in the same set, then do nothing.
3. U·Find(x): return the representative element of the set Sₓ that contains x.

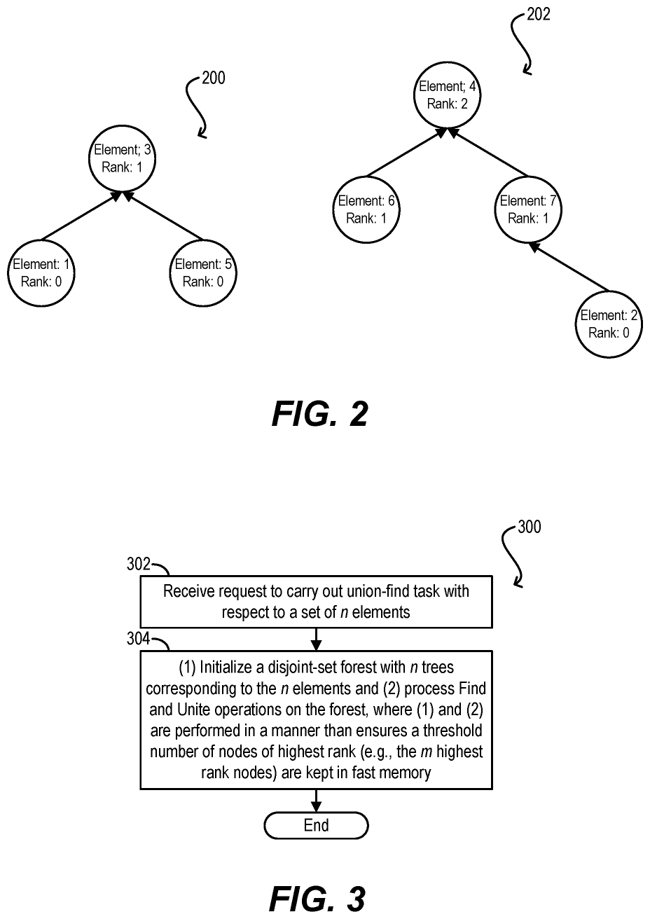

The standard algorithm for solving the union-find problem comprises implementing union-find data object U as a group of rooted trees, known as a disjoint-set forest, that is stored in a single tier of memory. Each set S of U is represented as a tree in this forest where the root node is S's representative element and each node in the tree-which corresponds to an element of S—holds a rank field and a pointer to its parent node (the root node has a self-referential parent pointer). The rank of a node x can be understood as the height of x within the tree, or in other words the number of nodes in the longest path between x and a leaf node. To illustrate this, FIG. 2 depicts an example disjoint-set forest comprising two trees 200 and 202. In this example, tree 200 corresponds to a first set with elements 1, 3 and 5 (where 3 is the representative element and thus the root) and tree 202 corresponds to a second set with elements 2, 4, 6, and 7 (where 4 is the representative element and thus the root). The rank of each node is shown.

In the standard union-find algorithm, Find(x) is performed by traversing from node x to tree root u via parent pointers (referred to as the find path) and returning u. In the worst case node x will be a leaf node and thus the time complexity for this operation is bounded by tree height. There are certain well-known path compaction techniques such as splitting, halving, and compression that can change parent pointers on a find path to point higher up in the tree, thereby reducing the time needed for subsequent Find operations that traverse the same nodes. However, these path compaction heuristics only improve amortized time complexity and not worst-case time complexity.

Unite(x, y) is performed by finding the two root nodes u←Find(x) and v←Find(y) and linking them together via a helper method Link(u, v) in accordance with their ranks. Specifically, if the rank of u is greater, the Link method sets u as a child of v (i.e., v←u·parent), and if the rank of v is greater, the Link method sets v as a child of u (i.e., u←v·parent). If the two ranks are equal, the Link method increments one of them and then follows the same rule. With this linking-by-rank heuristic, every tree of the disjoint-set forest is guaranteed to have a height of at most log n (where n is the number of elements that the union-find data object is initialized with). This in turn means that the worst-case time complexity for the union-find task, which is governed by tree height due to the Find operation, is O(log n).

If n is less than or equal to the size of fast memory tier 106(2) of tiered memory system 100 (i.e., m), union-find component 110 can simply apply the standard algorithm to fast memory tier 106(2) by placing the entirety of the disjoint-set forest there and thus implement union-find in a time-optimal manner. In other words, in this scenario union-find component 110 can operate as if system 100 consists of a single memory tier corresponding to fast memory tier 106(2) and can perform all memory accesses required by union-find operations against that tier, resulting in a total time complexity of O(c log n).

However, for purposes of the present disclosure, it is assumed that n is greater than the size of fast memory tier 106(2) (i.e., m) and less than the size of slow memory tier 106(1) (i.e., M)), with a constant (or super-constant) excess factor y≙n/m indicating the proportion of the data size to the fast memory tier size. As a result, union-find component 110 is constrained by that fact that it cannot fit the entirety of the disjoint-set forest within fast memory tier 106(2); instead, component 110 must place at least some fraction of the tree nodes in the forest in slow memory tier 106(1). The question raised by this setting (and answered by the present disclosure) is therefore the following: how can union-find component 110 arrange/manipulate the data of the disjoint-set forest across fast and slow memory tiers 106(2) and 106(1) to best take advantage of the faster speed of fast memory tier 106(2) and thus accelerate the union-find task? Or stated another way, how can union-find component 110 arrange/manipulate the data of the disjoint-set forest across fast and slow memory tiers 106(2) and 106(1) to achieve a speed up over simply implementing the standard union-find algorithm entirely in slow memory tier 106(1) (which has a time complexity of O(C log n))?

### 2. Solution Overview

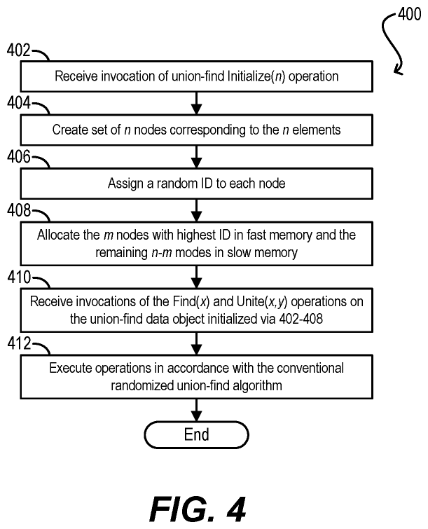

FIG. 3 depicts a flowchart 300 that provides a high level solution to the foregoing questions according to certain embodiments. Starting with step 302, union-find component 110 can receive a request to carry out the union-find task with respect to a set of n elements. This request can include an invocation of the union-find Initialize(n) operation.

Union-find component 110 can then proceed to (1) initialize a disjoint-set forest with n trees corresponding to singleton sets for the n elements and (2) process subsequent Find(x) and Unite(x, y) operations on the forest, where (1) and (2) are performed in a manner that ensures a threshold number of nodes of highest rank in the forest (e.g., the m highest rank nodes) are kept in fast memory tier 106(2) and the remaining nodes are kept in slow memory tier 106(1) (step 304). This property is referred to herein as the tiered memory union-find invariant property. Because the time complexities of the Find(x) and Unite(x, y) operations are dominated by find path traversals, this property guarantees that most memory accesses for the union-find task are executed in fast memory, resulting in a speed up over the standard union-find algorithm.

In particular, if the m nodes with highest rank in the disjoint-set forest are kept in fast memory tier 106(2) and the remaining n−m nodes are kept in slow memory tier 106(1), every find path traversal will take at most O(C log n/m+c log m)=O(C log y+c log m) time, which is significantly faster than the worst-case time complexity of the standard algorithm using only slow memory (i.e., O(C log n)). The mathematical reason for this is that the number of memory accesses in slow memory tier 106(1) is just logarithmic in the excess factor y rather than n. For example, in scenarios where n=m polylog(m) (which will be common in practice), the solution of flowchart 300 will require union-find component 110 to only perform O(log log n) memory accesses in slow memory tier 106(1), which is exponentially smaller than O(log n).

It should be noted that size m of fast memory tier 106(2) and size M of slow memory tier 106(2) are not necessarily the physical capacities of these memory tiers; rather, m and M are threshold memory sizes in tiers 106(2) and 106(1) respectively that union-find component 110 is authorized to use as part of executing the union-find task. In the scenario where union-find component 110 is the only consumer of tiers 106(2) and 106(1), m and M may be equal to their physical capacities. However, in alternative scenarios where other applications may concurrently access tiers 106(2) and 106(1), m and M may be less than the physical capacities of these tiers.

The remaining sections of this disclosure describe two approaches that may be employed by union-find component 110 for enforcing the tiered memory union-find invariant property: a static allocation approach in which component 110 statically allocates nodes in fast or slow memory at initialization time and a dynamic allocation approach in which component 110 moves nodes between the memory tiers dynamically as part of executing Unite operations. It should be appreciated that FIGS. 1-3 are illustrative and not intended to limit embodiments of the present disclosure. For example, although union-find component 110 is shown as being implemented in software as part of application 108, in some embodiments the techniques of the present disclosure may be implemented in hardware via a circuit such as a field-programmable gate array (FPGA) or an application-specific integrated circuit (ASIC). Further, although FIG. 1 depicts a particular arrangement of components within tiered memory system 100, other arrangements are possible (e.g., the functionality attributed to a particular component may be split into multiple components, components may be combined, etc.). Yet further, tiered memory system 100 may include other components or subcomponents that are not specifically described. One of ordinary skill in the art will recognize other variations, modifications, and alternatives.

### 3. Static Allocation

At a high level, the static allocation approach described in this section involves statically allocating, at initialization time (i.e., the time of executing the Initialize(n) operation), the highest rank nodes of the disjoint-set forest in fast memory tier 106(2) and the remaining nodes in slow memory tier 106(1). Once allocated in this manner, the nodes remain in their respective memory locations for the duration of the union-find task.

One challenge with implementing static allocation in the context of the standard union-find algorithm is that it is impossible to know a priori which nodes will achieve a high rank and thus should be allocated in fast memory at initialization; all nodes start with a rank of zero and those ranks are updated over time as Unite(x, y) operations are performed. To address this, the static allocation approach builds upon a variant of the standard union-find algorithm known as randomized union-find. With randomized union-find, each node is assigned a random, unique ID at the time of initialization. In addition, as part of executing the Link(u, v) helper method of Unite(x, y), a linking-by-ID heuristic is employed where the root node with the lower ID is always linked under the root node with the greater ID. For example, if the ID of root node u is greater, the Link method sets u as a child of v (i.e., v←u·parent). Conversely, if the ID of root node v is greater, the Link method sets v as a child of u (i.e., u←v·parent). This is different from the Link method of the standard algorithm, which performs linking by ranks rather than by random IDs.

It has been mathematically proven that the randomized union-find algorithm achieves a worst-case time complexity of O(log n) in expectation, and thus is similar in efficiency to the standard algorithm. However, the randomized algorithm has one key advantage: the IDs of the nodes, which ultimately correspond to their relative ranks due to the linking-by-ID heuristic, are known at the time of initialization. The static allocation approach exploits this by adapting the randomized algorithm into a tiered memory version as follows: in the Initialize(n) operation, the m nodes of highest ID are placed in fast memory tier 106(2) and the remaining nodes are placed in slow memory tier 106(1). The Find(x) and Unite(x, y) operations remain unchanged. With this adaptation, the tiered memory union-find invariant property is preserved, thereby allowing the tiered memory randomized algorithm to achieve a worst-case time complexity of O(C log y+c log m) in expectation.

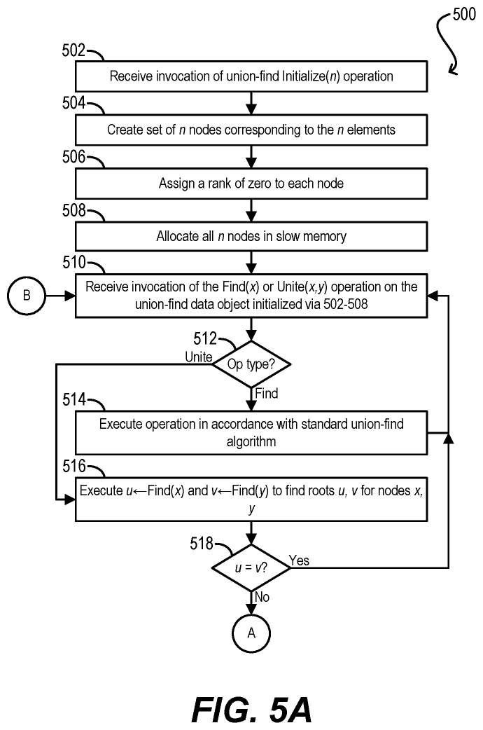

FIG. 4 depicts a flowchart 400 that summarizes the steps that may be performed by union-find component 110 for implementing the static allocation approach according to certain embodiments. Starting with step 402, union-find component 110 can receive an invocation of the union-find Initialize(n) operation for initializing a union-find data object with n elements. In response, union-find component 110 can create a set of n nodes corresponding to the n elements (step 404) and assign a random ID to each node, thereby placing the nodes in a uniformly random total order (step 406). Union-find component 110 can then allocate the m nodes with highest ID in fast memory tier 106(2) and the remaining n−m nodes in slow memory tier 106(1) (step 408).

At a later time, union-find component 110 can receive invocations of the union-find Find(x) and/or Unite(x, y) operations directed to the union-find data object initialized via steps 404-408 (step 410). In response to these invocations, union-find component 110 can execute the operations in accordance with the conventional randomized union-find algorithm (step 412). For example, in the case of Find(x), union-find component 110 can follow the parent pointers from node x until the root of its tree is found and return it. As part of this Find processing, union-find component 110 can optionally employ path compaction techniques (e.g., splitting, halving, compression, etc.) that change the parent pointers of nodes as it walks up the tree, thereby improving future find performance along that path. And in the case of Unite(x, y), union-find component 110 can find the two roots u←Find(x) and v←Find(y) and link them together via helper method Link(u, v) such that the root with the lower ID is linked under the root with the greater ID.

### 4. Dynamic Allocation

One downside with the static allocation approach is that it only guarantees worst-case time complexity of O(C log y+c log m) for the union-find task in expectation. The dynamic allocation approach described in this section achieves this time complexity guarantee deterministically by adapting the standard union-find algorithm to make fast-memory allocation choices in a dynamic fashion as Unite(x, y) operations occur.

In particular, with dynamic allocation, all n nodes are initially placed in slow memory tier 106(1) as part of the Initialize operation. Then, if a node increases in rank during Unite, a check is performed to determine whether the node's new rank is greater than or equal to a threshold rank R, where R is the ceiling of the binary logarithm of n divided by m (or in other words,

$$⌈ {log}_{2} \frac{n}{m} ⌉ ) .$$

If the answer is yes, the node is essentially moved from slow memory tier 106(1) to fast memory tier 106(2). It is well known that at most n/2^{R} nodes will achieve of rank of at least R. Accordingly, by using

$$R = ⌈ {log}_{2} \frac{n}{m} ⌉ ,$$

this approach guarantees that the m highest rank nodes will be placed in fast memory.

It should be noted that simply moving a node x from slow memory to fast memory can be inefficient; this is because any number of other nodes may be pointing to x as a parent, and thus moving x would require changing all of those parent pointers to point to x's new memory location. To overcome this problem, in some embodiments the foregoing approach may be optimized as follows: when a node x attains rank R, a clone of x, denoted as x′, is created in fast memory tier 106(2) (rather than simply moving x to that tier). In addition, the rank of clone x′ is set to R (to match the new rank of node x), the parent pointer of x is set to point to x′, and the parent pointer of x′ is set to point to itself.

With this structure, the cost of changing all parent pointers pointing to node x is avoided. At the same time, every find path including node x that starts in slow memory will switch to fast memory upon reaching x and thereafter remain in fast memory until the root is reached. Because R is chosen to equal

$$⌈ {log}_{2} \frac{n}{m} ⌉$$

and ranks are non-negative and strictly increasing along a path (apart from a node and its clone), this means that at most

$$O ( ⌈ {log}_{2} \frac{n}{m} ⌉ )$$

of the find path will be in slow memory and the remainder will be in fast memory, resulting in the desired time complexity of O(C log y+c log m).

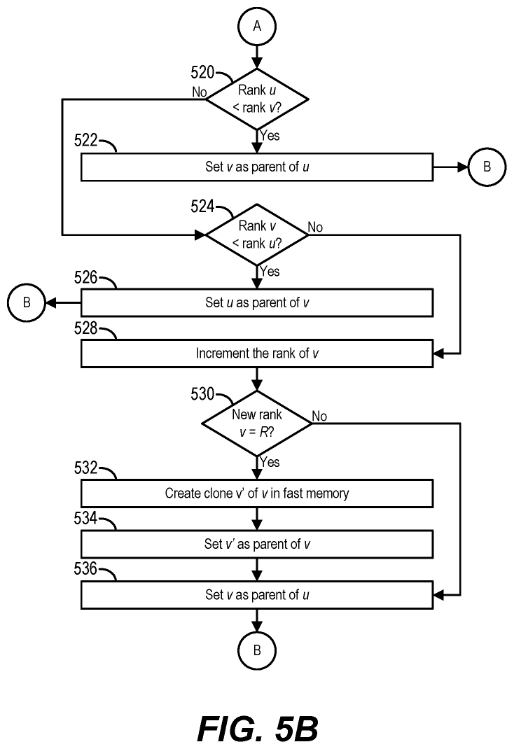

FIGS. 5A and 5B depict a flowchart 500 that summarizes the steps that may be performed by union-find component 110 for implementing the dynamic allocation approach (including the cloning optimization noted above) according to certain embodiments. Starting with step 502 of FIG. 5A, union-find component 110 can receive an invocation of the union-find Initialize(n) operation for initializing a union-find data object with n elements. In response, union-find component 110 can create a set of n nodes corresponding to the n elements (step 504) and assign a rank of zero to each node (step 506). Union-find component 110 can then allocate all n nodes in slow memory tier 106(1) (step 508).

At a later time, union-find component 110 can receive an invocation of the union-find Find(x) or Unite(x, y) operation directed to the union-find data object initialized via steps 504-508 (step 510). If the received invocation is for Find(x) (step 512), union-find component 110 can execute the operation in accordance with the standard union-find algorithm (which may include a path compaction technique as mentioned previously) (step 514). Union-find component 110 may then loop back to step 510 to receive and process the next Find/Unite operation invocation.

However, if the received invocation at step 512 is for Unite(x, y), union-find component 110 can execute u←Find(x) and v←Find(y) to find the roots u, v of nodes x, y (step 516) and check whether u is the same as v (step 518). If the answer is yes, no linking is needed and union-find component 110 can loop back to step 510. Otherwise, union-find component 110 can proceed to link together u and v (i.e., execute Link(u, v)) as shown in FIG. 5B.

In particular, starting with step 520 of FIG. 5B, union-find component 110 can check whether the rank of u is less than the rank of v. If so, union-find component 110 can set v as the parent of u (step 522) and loop back to step 510.

If the answer at step 520 is no, union-find component 110 can further check whether the rank of v is less than the rank of u (step 524). If so, union-find component 110 can set u as the parent of v (step 526) and loop back to step 510.

If the answer at step 524 is no, that means u and v have the same rank. In this scenario, union-find component 110 can increment the rank of one of the two roots (in this example, v) (step 528) and check whether the new rank of v is equal to threshold rank R (step 530). If the answer is yes, union-find component 110 can create a clone v′ of v in fast memory tier 106(2) (step 532) and set v′ as the parent of v (step 534). Finally, at step 536, union-find component 110 can set v as the parent of u and loop back to step 510 to process the next incoming union-find operation.

Certain embodiments described herein can employ various computer-implemented operations involving data stored in computer systems. For example, these operations can require physical manipulation of physical quantities-usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

1. A method comprising:
receiving, by computer system including first and second memory tiers, a request to carry out union-find with respect to a set of n elements, wherein n is a number of elements that a union-find object is initialized with;
initializing, by the computer system, a disjoint-set forest comprising a plurality of trees, each tree including a node corresponding to an element in the set of n elements; and
executing, by the computer system, one or more union-find operations on the disjoint-set forest,
wherein the initializing and the executing comprises storing a threshold number of nodes of highest rank in the disjoint-set forest in the first memory tier.

2. The method of claim 1 wherein the first memory tier is faster than the second memory tier.

3. The method of claim 1 wherein the threshold number is based on a size of the first memory tier.

4. The method of claim 1 wherein the initializing comprises:
assigning a random identifier (ID) to each node; and
allocating the threshold number of nodes with highest random ID in the first memory tier.

5. The method of claim 4 wherein the executing comprises, upon receiving an invocation of a unite operation with respect to two nodes x and y:
finding a root node u for node x, wherein x is a first element in the set of n elements, u is a first root node corresponding to the first element;
finding a root node v of node y, wherein y is a second element in the set of n elements, v is a second root node corresponding to the second element;
upon determining that root node u's random ID is less than root node v's random ID, setting root node v as a parent of root node u; and
upon determining that root node v's random ID is less than root node u's random ID, setting root node u as a parent of root node v.

6. The method of claim 1 wherein the initializing comprises:
assigning a rank of zero to each node; and
allocating all n nodes in the second memory tier.

7. The method of claim 6 wherein the executing comprises, upon receiving an invocation of a unite operation with respect to two nodes x and y:
finding a root node u for node x, wherein x is a first element in the set of n elements, u is a first root node corresponding to the first element;
finding a root node v of node y, wherein y is a second element in the set of n elements, v is a second root node corresponding to the second element;
upon determining that root node u's rank is less than root node v's rank, setting root node v as a parent of root node u;
upon determining that root node v's rank is less than root node u's rank, setting root node u as a parent of root node v; and
upon determining that root node v's rank is equal to root node u's rank:
incrementing root node v's rank;
setting root node v as a parent of root node u; and
upon determining that root node v's incremented rank equals a threshold rank:
creating a clone v′ of root node v in the first memory tier; and
setting clone v′ as a parent of root node v.

8. A non-transitory computer readable storage medium having stored thereon program code executable by a computer system including first and second memory tiers, the program code embodying a method comprising:
receiving a request to carry out union-find with respect to a set of n elements, wherein n is a number of elements that a union-find object is initialized with;
initializing a disjoint-set forest comprising a plurality of trees, each tree including a node corresponding to an element in the set of n elements; and
executing one or more union-find operations on the disjoint-set forest,
wherein the initializing and the executing comprises storing a threshold number of nodes of highest rank in the disjoint-set forest in the first memory tier.

9. The non-transitory computer readable storage medium of claim 8 wherein the first memory tier is faster than the second memory tier.

10. The non-transitory computer readable storage medium of claim 8 wherein the threshold number is based on a size of the first memory tier.

11. The non-transitory computer readable storage medium of claim 8 wherein the initializing comprises:
assigning a random identifier (ID) to each node; and
allocating the threshold number of nodes with highest random ID in the first memory tier.

12. The non-transitory computer readable storage medium of claim 11 wherein the executing comprises, upon receiving an invocation of a unite operation with respect to two nodes x and y:
finding a root node u for node x, wherein x is a first element in the set of n elements, u is a first root node corresponding to the first element;
finding a root node v of node y, wherein y is a second element in the set of n elements, v is a second root node corresponding to the second element;
upon determining that root node u's random ID is less than root node v's random ID, setting root node v as a parent of root node u; and
upon determining that root node v's random ID is less than root node u's random ID, setting root node u as a parent of root node v.

13. The non-transitory computer readable storage medium of claim 8 wherein the initializing comprises:
assigning a rank of zero to each node; and
allocating all n nodes in the second memory tier.

14. The non-transitory computer readable storage medium of claim 13 wherein the executing comprises, upon receiving an invocation of a unite operation with respect to two nodes x and y:
finding a root node u for node x, wherein x is a first element in the set of n elements, u is a first root node corresponding to the first element;
finding a root node v of node y, wherein y is a second element in the set of n elements, v is a second root node corresponding to the second element;
upon determining that root node u's rank is less than root node v's rank, setting root node v as a parent of root node u;
upon determining that root node v's rank is less than root node u's rank, setting root node u as a parent of root node v; and
upon determining that root node v's rank is equal to root node u's rank:
incrementing root node v's rank;
setting root node v as a parent of root node u; and
upon determining that root node v's incremented rank equals a threshold rank:
creating a clone v′ of root node v in the first memory tier; and
setting clone v′ as a parent of root node v.

15. A computer system comprising:
a processor;
a first memory tier and a second memory tier; and
a non-transitory computer readable medium having stored thereon program code that causes the processor to:
receive a request to carry out union-find with respect to a set of n elements,
wherein n is a number of elements that a union-find object is initialized with;
initialize a disjoint-set forest comprising a plurality of trees, each tree including a node corresponding to an element in the set of n elements; and
execute one or more union-find operations on the disjoint-set forest,
wherein the initializing and the executing comprises storing a threshold number of nodes of highest rank in the disjoint-set forest in the first memory tier.

16. The computer system of claim 15 wherein the first memory tier is faster than the second memory tier.

17. The computer system of claim 15 wherein the threshold number is based on a size of the first memory tier.

18. The computer system of claim 15 wherein the initializing comprises:
assigning a random identifier (ID) to each node; and
allocating the threshold number of nodes with highest random ID in the first memory tier.

19. The computer system of claim 18 wherein the executing comprises, upon receiving an invocation of a unite operation with respect to two nodes x and y:
finding a root node u for node x, wherein x is a first element in the set of n elements, u is a first root node corresponding to the first element;
finding a root node v of node y, wherein y is a second element in the set of n elements, v is a second root node corresponding to the second element;
upon determining that root node u's random ID is less than root node v's random ID, setting root node v as a parent of root node u; and
upon determining that root node v's random ID is less than root node u's random ID, setting root node u as a parent of root node v.

20. The computer system of claim 15 wherein the initializing comprises:
assigning a rank of zero to each node; and
allocating all n nodes in the second memory tier.

21. The computer system of claim 20 wherein the executing comprises, upon receiving an invocation of a unite operation with respect to two nodes x and y:
finding a root node u for node x, wherein x is a first element in the set of n elements, u is a first root node corresponding to the first element;
finding a root node v of node y, wherein y is a second element in the set of n elements, v is a second root node corresponding to the second element;
upon determining that root node u's rank is less than root node v's rank, setting root node v as a parent of root node u;
upon determining that root node v's rank is less than root node u's rank, setting root node u as a parent of root node v, and
upon determining that root node v's rank is equal to root node u's rank:
incrementing root node v's rank;
setting root node v as a parent of root node u; and
upon determining that root node v's incremented rank equals a threshold rank:
creating a clone v′ of root node v in the first memory tier; and
setting clone v′ as a parent of root node v.
